(19) United States
(12) Patent Application Publication
(10) Pub. No.: US 2004/0032821 A1
(43) Pub. Date: Feb. 19, 2004

(54) Device and method to dampen the vibrations of a rotating storage disk in a data storage device

(75) Inventor: Olaf Winterhalter, Epfendorf (DE)

Correspondence Address: SCHULTE ROTH & ZABEL LLP, ATTN: JOEL E. LUTZKER, 919 THIRD AVENUE, NEW YORK, NY, 10022, US

(73) Assignee: Minebea Co., Ltd., Nagano-Ken (JP)

(21) Appl. No.: 10/458,886

(22) Filed: Jun. 11, 2003

(30) Foreign Application Priority Data
Jun. 12, 2002 (DE) 102 26 016.8

(51) Int. Cl. G11B 23/00; G11B 25/00

(52) U.S. Cl. 369/266; 369/263

(57) ABSTRACT

A device and a method to dampen the vibrations of a rotating disk in a data storage device, having at least one read/write device to read and write data onto and from the storage disk, and a drive unit including a stator and a rotor supporting the storage disk, whereby stator and rotor are set rotatable to each other by means of a bearing arrangement. One side of the storage disk forms a bearing surface which lies directly opposite a stationary bearing surface wherein at least one of the two bearing surfaces features a groove pattern which is formed in such a way that vibrations of the storage disk arising from its rotation are dampened or compensated.

### CROSS-REFERENCE TO RELATED APPLICATIONS

This application claims all rights of priority to German Patent Application Serial No. DE102 26 016.8, filed Jun. 12, 2002 (pending).

### FIELD OF THE INVENTION

The following invention relates to a device and a method to dampen the vibrations of a rotating disk in a data storage device.

### BACKGROUND OF THE INVENTION

Data storage devices, for example hard disk drives, CD drives, DVD drives or other optical drives, are known in the art. Such drives typically include a spindle motor to rotate a data storing medium, for example magnetic disk. Spindle motor provided in a data storage device typically includes a bearing system supporting a rotor assembly of the spindle motor with respect to a stator assembly. The bearing system can be formed as a ball bearing system or a hydrodynamic bearing system.

U.S. Pat. No. 3,855,624 discloses a magnetic storage device having a hydrodynamic bearing arrangement instead of a conventional bearing arrangement. The disclosed hydrodynamic bearing arrangement has a spirally grooved air bearing which is formed between the opposing bearing surfaces of the storage disk and the housing which is parallel to the storage disk. The proposed spiral grooved bearing can take up axial loads in two opposite directions without requiring initial stiffness from outside. It is known that the grooves in a spiral groove bearing force the surrounding air, which acts as a lubricant, between the bearing surfaces so that excess pressure is created and the bearing is able to carry the load. In this process, the bearing surfaces separate from each other until an equilibrium is created between the load carrying capacity and the prevailing load. The load carrying capacity of the bearing increases when the number of revolutions per minute of the storage disk is increased. For an push/pull thrust bearing, the bearing surfaces are provided with two groove patterns featuring different curvatures. These patterns are arranged conversely to each other and have different dimensions. Since the patterns are arranged conversely to each other, the lubricant creates excess pressure in a specific area of the bearing and low pressure in another area. Excess pressure is created at the edge of the disk and low pressure is created at its center. The latter represents an inner load which, for a specific distance between the two bearing surfaces, compensates the load carrying capacity and supplies the initial stiffness for the bearing. Differing dimensions chosen for the two groove patterns can influence the stiffness of the bearing.

With the ongoing miniaturization and increase in capacity of hard disk drives, the storage disks used are becoming increasingly smaller and their revolutions per minute ever greater. For high rpms of over 10,000 rounds/min, vibrations occurring in the storage disk represent a significant problem. Storage disks can vibrate in different modes, e.g. wave-like in the circumferential direction or in the so-called butterfly mode in which the disk moves up and down (similar to wings). These vibrations, particularly if their frequencies are close to the inherent frequencies of the system, can result in errors in reading and writing data or, in the worst case scenario, in the read/write head touching the storage disk which will crash the hard disk drive.

This is why attempts have been made to minimize the amplitude of vibrations and to shift the inherent frequency(ies) of the storage disk(s) to a higher frequency region by increasing material thickness and by using materials having a high degree of elasticity. Opposed to this is the fact that thicker storage disks mean an increased mass, a higher moment of inertia and thus longer run-up times for the data storage drive. In addition, the thickness of the disks largely determines the overall height of the hard disk drive which is why efforts are made in the opposite direction, i.e., to keep the disks as thin as possible.

### SUMMARY OF THE INVENTION

The object of the invention is to provide a device and a method to dampen the vibration of a rotating storage disk in a data storage device by means of which inherent vibrations of the storage disk are considerably reduced or avoided.

According to one aspect of the invention, one side of the storage disk forms a rotational bearing surface which lies directly opposite a stationary bearing surface, whereby at least one of the bearing surfaces features a groove pattern which is formed in such a way that vibrations in the storage disk arising from its rotation are dampened or compensated.

Due to the groove pattern, concentric, annular areas on the storage disk are subjected to a varying, hydrodynamically created, positive and/or negative pressure, whereby the tendency to vibrate and the amplitude of the vibration are reduced.

The advantage of this kind of vibration compensation is that the storage disk can be kept very thin and materials which could not previously be used in the manufacture of a storage disk can now be used.

Moreover, vibrations in the storage disk can be effectively dampened even for very high rpms of well over 15,000 rounds/min. The design of the groove pattern has to be individually tailored to the material, the thickness and the desired rpm of the storage disk. Even at very high rpms, the storage disk rotates extremely smoothly which means that the distance between the recording tracks, as well as the distance between the read/write head and the surface of the storage disk, can be reduced that is required to achieve higher storage densities.

The groove pattern preferably consists of at least two annular, concentric grooved areas whereby one grooved area is formed in such a way that low pressure is created in the existing air gap between the bearing surfaces, while the other grooved area is formed in such a way that excess pressure is formed between the bearing surfaces.

Due to the differential pressure zones, with the low pressure preferably at the center and excess pressure at the edge of the storage disk, stiffness of the storage disk is increased and the tendency to vibrate is either reduced or shifted to an uncritical higher frequency region, away from the essential frequencies of the system.

The pressure zones are created by spiral-shaped grooves, whereby the curvature of the grooves in one of the grooved areas runs conversely to the curvature of the grooves in the other grooved area so that the differential pressure distribution described above is created.

In another aspect of the present invention the groove pattern is not only used to reduce storage disk vibrations but also as an axial bearing for the bearing arrangement of the rotor. This twofold function of the groove pattern as a vibration damper and an axial bearing has a positive impact on the overall size of the spindle motor construction, the achievable storage density and the reliability of the storage device.

In accordance with empirical studies, it has been established that glass is a suitable material for the manufacture of storage disks. On one hand, its stiffness is sufficiently high even where thin disks are concerned, and, on the other hand, the groove pattern can be relatively easily formed on a glass disk, for example, by using an appropriate etching technique.

The grooving, however, can also be formed on the stationary bearing surface, either on an extra disk or on a part of the housing, for instance, on the inner surface of the baseplate itself.

The invention is especially beneficial if the storage device involved has only one storage disk. Here, one side of the storage disk is used as a bearing or a vibration damper while the other side acts as a magnetic or optical storage medium. A further benefit of this embodiment is its non-mechanically enclosed design. Design-related assembling and manufacturing tolerances are reduced simply to the manufacture of an additional planar bearing surface. This allows a maximum of geometric precision.

For start-up, special precautions have to be taken in the arrangement of motor and storage disk which prevents the storage disk from adhering to the bearing surface due to the evenness of both parts. In one embodiment of the invention, when the motor is stationary, in other words it rotates with zero rpm, the storage disk does not lie fully on the bearing surface but only has a small contact surface with it. It is only when the storage disk rotates that the stabilizing push/pull load distribution between the two even bearing surfaces is created.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS

The invention is illustrated by way of example and not limitation and the figures of the accompanying drawings in which like references denote like or corresponding parts, and in which:

FIG. 1 is a cross-sectional view of a storage device according to the invention in the form of a hard disk drive;

FIG. 2 is a bottom view of the bearing surface of the storage disk with a groove pattern formed in it;

FIG. 3 is a cross-sectional view of the storage disk;

FIG. 4 is a chart showing an example of the distribution of pressure in the gap between the bearing surfaces; and

FIG. 5 is an exploded bottom view of the storage device.

### DETAILED DESCRIPTION OF THE PREFERRED EMBODIMENTS AND THE DRAWINGS

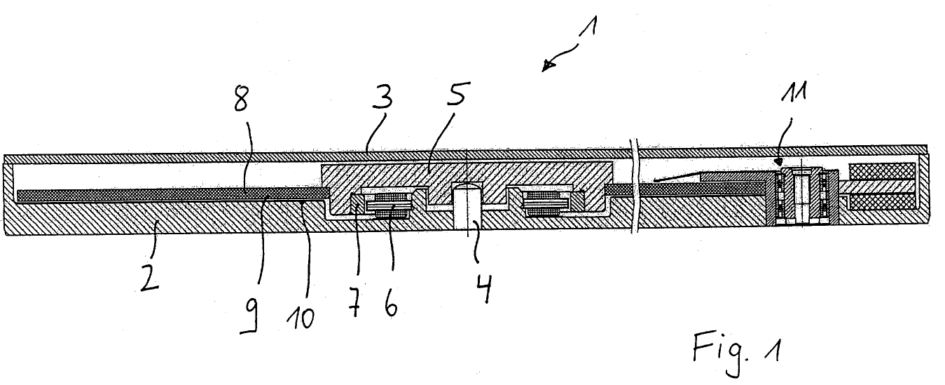

The hard disk drive 1 according to FIG. 1 includes a stationary baseplate 2, which is sealed by a cover 3 and contains at least one storage disk 8. A bearing pin 4 is accommodated in the baseplate 2 which forms a support for the rotor 5 of the drive motor. The drive motor includes a stator stack 6 arranged on the baseplate which, in a known art, sets up an alternating electrical field at the permanent magnets 7 on the inner circumference of the rotor and makes the rotor 5 turn.

The storage disk 8 is arranged on the rotor 5 and is set into rotation together with the rotor. By means of a read/write device 11, whose construction is not described in detail, data can be written onto the storage disk 8 and read off it again.

The lower side of the storage disk 8 forms a bearing surface 9 which lies directly opposite and parallel to a bearing surface 10 formed by the baseplate 2. An air gap exists between the bearing surfaces 9, 10.

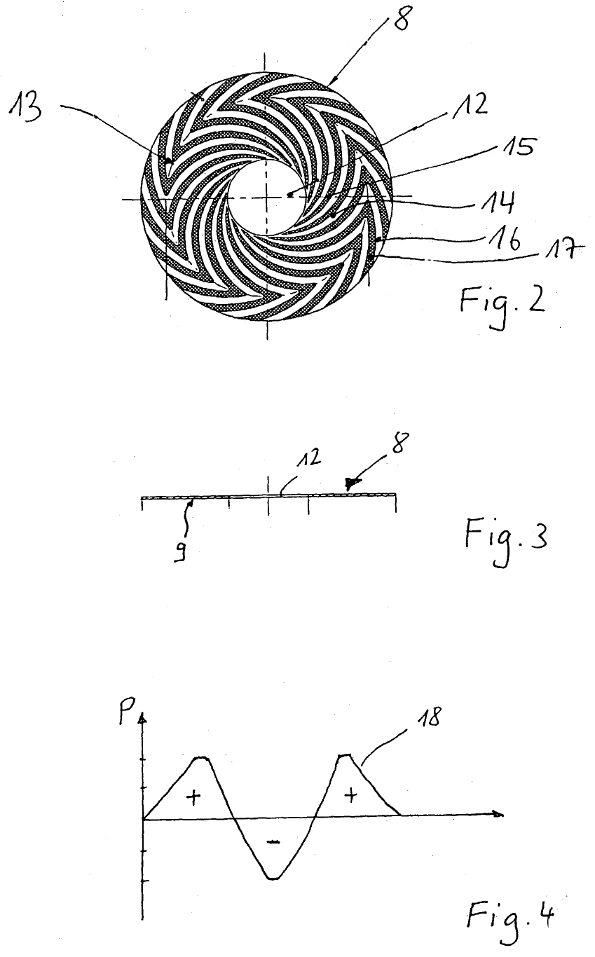

It can be seen from FIGS. 2 and 3, that the storage disk 8 features an opening 12 for its mounting on the rotor 5. The bearing surface 9 of the storage disk 8 is provided with a groove pattern 13 which includes at least two grooved areas 14, 16 each featuring a plurality of spiral-shaped grooves 15, 17 arranged around the opening 12. The depth of the grooves is preferably a matter of a few μm. In the example illustrated, each grooved area 14, 16 includes eighteen grooves 15 or 17 set at regular intervals with respect to each other.

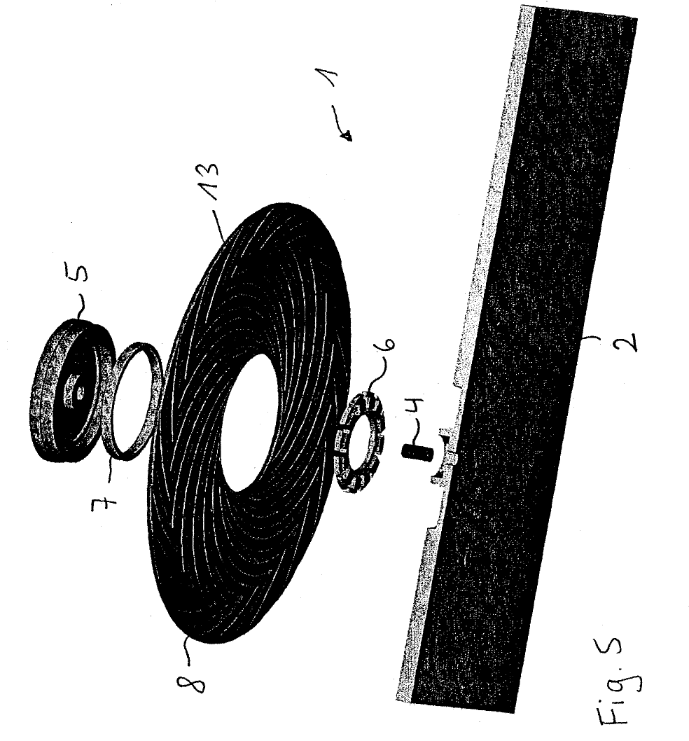

Grooves 15 in the inner grooved area 14 are arranged in such a way that during rotation of the storage disk 8 they create low pressure in the air gap between the bearing surfaces. Grooves 17 in grooved area 16 run conversely with respect to grooves 15 and create an excess pressure during rotation. A typical pressure distribution 18 created in the air gap by the groove pattern is illustrated in FIG. 4. This pressure distribution results in a kind of load or initial stiffness on the storage disk, whereby the inherent vibrations of the storage disk are considerably dampened. The groove pattern 13 is laid out in such a way that the vibrations in the storage disk are reduced particularly in the region of the inherent frequencies of the entire system and the storage disk rotates more smoothly.

A person skilled in the art would recognize that the groove pattern 14 can be arranged on the stationary bearing surface 10 of the baseplate 2 instead of on the bearing surface 9 of the storage disk 8. It is also conceivable that a groove pattern is provided on both bearing surfaces 9 and 10.

In another aspect of the invention, the groove pattern 13 formed on the bearing surfaces 9, 10 form a bearing for the axial and radial bearing of the rotor 5, in addition to accomplishing the vibration damping effect. On one hand, the groove pattern 13 creates excess pressure which determines the load capacity of the bearing. On the other hand, the groove pattern 13 creates low pressure which creates initial internal stiffness which counteracts the load capacity. This embodiment particularly makes it possible to design very compact data storage drives since greater storage density can be realized through vibration damping without requiring an extra axial bearing arrangement.

Finally, FIG. 5 shows an exploded view of the hard disk drivel with its main components, i.e., baseplate 2, bearing pin 4, stator stack 6, storage disk 8, ring magnet 7 and rotor 5. The groove pattern 13 is provided on the underside of the storage disk 8, i.e. the side directly opposite the baseplate, as can be seen in FIG. 5.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Other undescribed variations or modifications may be possible. For example, where multiple alternative embodiments are described, in many cases it will be possible to combine elements of different embodiments, or to combine elements of the embodiments described here with other modifications or variations that are not expressly described. Many of those undescribed variations, modifications and variations are within the literal scope of the following claims, and others are equivalent.

What is claimed is:

1. A vibrations dampening device for a rotating storage disk of a data storage device, said vibrations dampening device comprising:
a stator;
a rotor supporting said rotating storage disk; and
a bearing arrangement facilitating rotation of said rotor with respect to said stator,
wherein one side of said rotating storage disk forms a first bearing surface, wherein a second bearing surface is formed as a stationary bearing surface, wherein said first bearing surface lies directly opposite said stationary bearing surface, and wherein at least one of said bearing surfaces further comprises a groove pattern formed in such a way as to dampen vibrations of said rotating storage disk.

2. The vibrations dampening device according to claim 1, wherein said groove pattern further comprises at least two annular, concentric grooved areas, and wherein a first grooved area of said at least two grooved areas is formed in such a way that low pressure is created in an air gap between said bearing surfaces, while a second grooved area is formed in such a way that excess pressure is created in said air gap.

3. The vibrations dampening device according to claim 2, wherein said first and second grooved areas further comprise spiral-shaped grooves, and wherein a curvature of said spiral-shaped grooves of said first grooved area runs conversely to a curvature of said spiral-shaped grooves of said second grooved area.

4. The vibrations dampening device according to claim 1, wherein said groove pattern is configured in such a way that said bearing surfaces form an axial bearing and a radial bearing supporting said rotor.

5. The vibrations dampening device according to claim 1, wherein said storage disk is a magnetic disk, magneto-optical disk or optical storage disk.

6. The vibrations dampening device according to claim 1, wherein said storage disk is made of a glass material.

7. A vibrations dampening device for a rotating storage disk of a data storage device, comprising:
at least two concentric annular areas formed on said rotating storage disk,
wherein said concentric annular areas are subjected to varying, hydrodynamically created pressure in such a way that the vibrations of said rotating storage disk arising from its rotation are dampened or compensated.

8. The vibrations dampening device according to claim 7, wherein said rotating storage disk comprises a first bearing surface, and wherein said hydrodynamic pressure is created by a groove pattern formed on said first bearing surface.

9. The vibrations dampening device according to claim 7, further comprising a stationary bearing surface, wherein said hydrodynamic pressure is created by a groove pattern formed on said stationary bearing surface.

10. The vibrations dampening device according to claim 7, wherein said rotating storage disk comprises a first bearing surface, wherein said vibrations dampening device further comprising a stationary bearing surface located opposite said first bearing surface, and wherein said bearing surfaces are provided with a groove pattern.
